(19) United States
(12) Patent Application Publication
(10) Pub. No.: US 2024/0390996 A1
(43) Pub. Date: Nov. 28, 2024

(54) ROTARY TOOL AND METHOD FOR MANUFACTURING MACHINED PRODUCT

(71) Applicant: KYOCERA CORPORATION, Kyoto-shi, Kyoto (JP)

(72) Inventor: Suguru ONCHI, Kyoto (JP)

(21) Appl. No.: 18/695,852

(22) PCT Filed: Oct. 3, 2022
(86) PCT No.: PCT/JP2022/036899

§ 371 Date: Mar. 27, 2024

(30) Foreign Application Priority Data
Oct. 7, 2021 (JP) 2021-165452

(51) Int. Cl. B23C 5/10; B23C 5/28

(52) U.S. Cl. CPC B23C 5/10; B23C 5/282

(57) ABSTRACT

A rotary tool includes a coolant hole opening in a flank face. The coolant hole includes, in a cross section orthogonal to a rotational axis of the rotary tool, a first portion protruding toward a front in a rotation direction of the rotational axis and toward an outer peripheral side and having a convex curved shape, a second portion protruding toward the front in the rotation direction and toward a central side having a convex curved shape, and a third portion protruding toward a rear in the rotation direction and toward the central side and having a convex curved shape.

### TECHNICAL FIELD

The present disclosure relates to a rotary tool used for machining of a workpiece and a method for manufacturing a machined product. Examples of a rotary tool include an end mill, a drill, and a reamer.

### BACKGROUND OF INVENTION

Examples of known rotary tools to be used in machining of workpieces such as those made of metal include drills described in Patent Documents 1 and 2. The drills described in Patent Documents 1 and 2 include a coolant hole extending from a rear end to a tip end and opening at the tip end. A cooling liquid may be injected from the coolant hole during cutting, and the drill and the workpiece can be cooled.

### CITATION LIST

### Patent Literature

Patent Document 1: JP 2011-020255 A
Patent Document 2: JP 2017-205844 A

### SUMMARY

A rotary tool according to an aspect of the present disclosure includes a body extending along a rotational axis from a first end to a second end and having a cylindrical shape. The body includes a flank face located at the first end, a flute extending from the flank face toward the second end and configured to discharge a chip, a cutting edge located at an intersection of the flank face and the flute, and a coolant hole extending from the second end toward the first end and opening in the flank face. The coolant hole includes, in a cross section orthogonal to the rotational axis, a first portion protruding toward a front in a rotation direction of the rotational axis and toward an outer peripheral side and having a convex curved shape, a second portion protruding toward the front in the rotation direction and toward a central side and having a convex curved shape, and a third portion protruding toward a rear in the rotation direction and toward the central side and having a convex curved shape.

### BRIEF DESCRIPTION OF THE DRAWINGS

FIG. 1 is a perspective view of a rotary tool according to the present embodiment.

FIG. 2 is an enlarged view of a region A1 illustrated in FIG. 1.

FIG. 3 is a side view of the rotary tool.

FIG. 4 is a front view of the rotary tool.

FIG. 5 is a cross-sectional view taken along an arrow line III-III in FIG. 3, and a partial enlarged view.

FIG. 6 is a view illustrating a shape of a coolant hole by using the cross-sectional view taken along the arrow line III-III in FIG. 3.

FIG. 7 is a view illustrating a flow of a cooling liquid ejected from the coolant hole by using the front view of the rotary tool.

FIG. 8 is a schematic view illustrating a process of a method for manufacturing a machined product according to an embodiment.

### DESCRIPTION OF EMBODIMENTS

Detailed description will be given below of the rotary tool and the method for manufacturing a machined product of an embodiment of the present disclosure with reference to the diagrams. However, each of the figures, which will be referred to below, is a simplified representation of only components necessary for description of the embodiments, for convenience of description. Accordingly, the rotary tool can have any component that is not illustrated in each of the figures referred to. The dimensions of the components in the figures do not faithfully represent the actual dimensions of the components, the dimension ratios of the components, or the like.

In the present disclosure, the rotational axis refers to a rotational axis center of the rotary tool, and the circumferential direction refers to a direction around the rotational axis. The radial direction is a direction orthogonal to the rotational axis and the circumferential direction, the radially inner side is a direction approaching the rotational axis or a side approaching the rotational axis in the radial direction, and the radially outer side is a direction away from the rotational axis or a side away from the rotational axis in the radial direction. The outer peripheral side refers to an outer peripheral surface side of the rotary tool, and the central side refers to an inner peripheral portion side including a center of the rotary tool where the rotational axis is located.

### 1. Rotary Tool

### Schematic Configuration of Rotary Tool 1

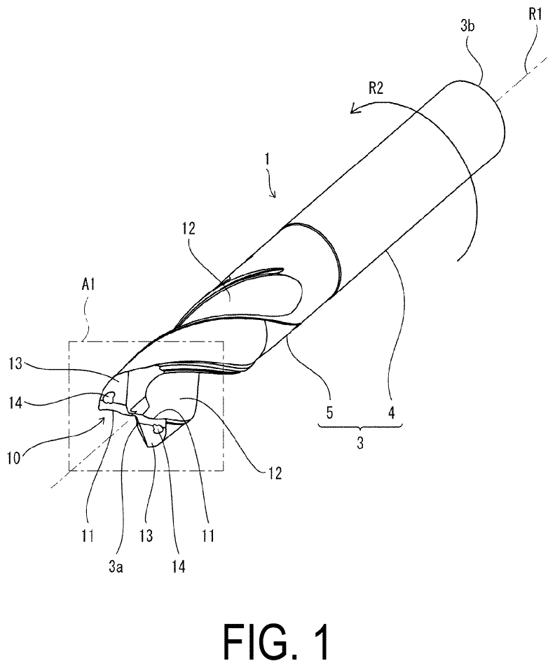

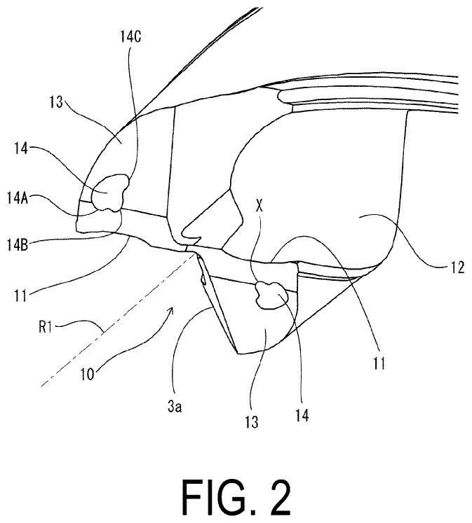

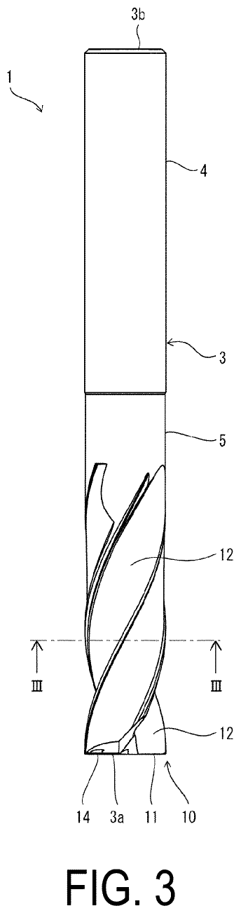

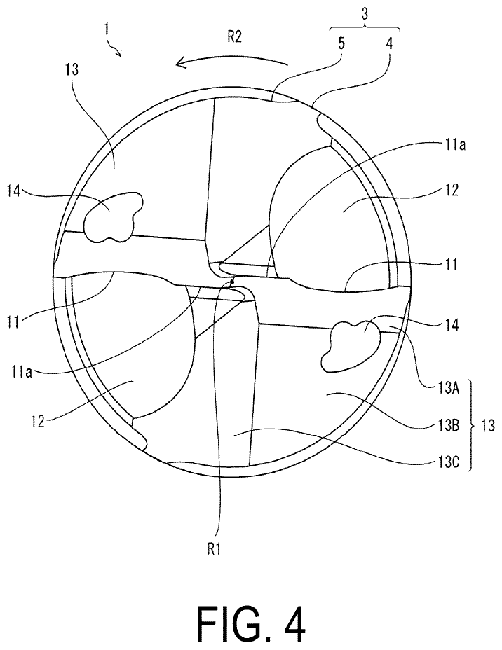

First, a configuration of a rotary tool 1 according to the present embodiment will be described using FIGS. 1 to 4. FIG. 1 is a perspective view of a rotary tool 1 according to the present embodiment. FIG. 2 is an enlarged view of a region A1 illustrated in FIG. 1. FIG. 3 is a side view of the rotary tool 1. FIG. 4 is a front view of the rotary tool 1.

As illustrated in FIG. 1 and FIG. 3, a drill can be cited as an example of the rotary tool 1, and the drill is illustrated as the rotary tool 1 in the present embodiment. More specifically, the drill illustrated in FIG. 1 is called a flat drill having a tip end angle of 180 degrees. Examples of the rotary tool may include an end mill and a reamer. Naturally, the tip end angle of the drill is not limited to 180 degrees.

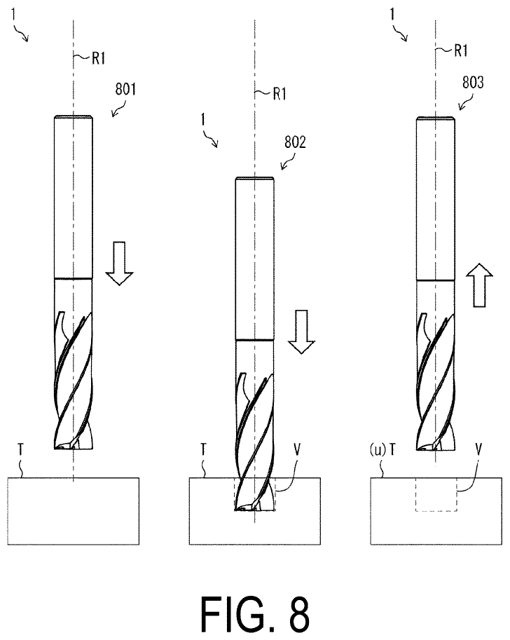

As illustrated in FIG. 1, the rotary tool 1 according to the present embodiment includes a body 3 extending along a rotational axis R1 from a first end 3a to a second end 3b and having a cylindrical shape. The first end 3a may be replaced with a tip end 3a and the second end 3b may be replaced with a rear end 3b. The rotary tool 1 has the body 3. The body 3 is rotatable around an axis of the rotational axis R1 and has a cutting portion 10 at the first end 3a that is one end portion in the axial direction of the rotational axis R1. As illustrated in FIG. 8 described below, the cutting portion 10 performs cutting in contact with a workpiece T.

The body 3 in the so-called solid-type rotary tool 1 may be made of, for example, a hard material. Examples of the hard material may include high-speed tool steel, cemented carbide, ceramics, cermet, cubic boron nitride (cBN), and polycrystalline diamond (PCD). In the solid type, at least the cutting portion 10 may be made of the above-described hard material, and the cutting portion 10 made of the above-described hard material may be brazed to a metal member. The rotary tool may be a tool that is commonly referred to as a tip exchange type tool and is constituted by a holder and a cutting insert. In this case, the cutting insert for cutting the workpiece T may be made of, for example, the above-described hard material.

The body 3 may include a portion referred to as a shank portion 4 and a portion referred to as a main body 5, as illustrated in FIG. 1 and FIG. 3. The shank portion 4 is positioned at the second end 3b side, and the main body 5 is positioned closer to the first end 3a than the shank portion 4. The shank portion 4 is a portion that can be gripped by a spindle being rotatable or the like in a machine tool. The cutting portion 10 is formed on the first end 3a side of the main body 5. A flute 12 extending from the first end 3a is formed in a spiral manner on an outer peripheral surface of the main body 5.

Although described in detail below, the rotary tool 1 drills the workpiece T (refer to FIG. 8) while the shank portion 4 is gripped by a machine tool, rotated in a rotation direction R2 around the axis of the rotational axis R1 and fed toward the first end 3a side.

### Cutting Portion

As illustrated in FIGS. 2 and 4, the cutting portion 10 located on the first end 3a side has a cutting edge 11, an opening of a flute 12, a flank face 13, and an opening of a coolant hole 14. FIG. 4 is a front view of the rotary tool 1 as viewed from the first end 3a side. A view from the first end 3a side is referred to as a front view.

The flank face 13 is located at the first end 3a. As illustrated in FIG. 4, in the present embodiment, the flank face 13 is formed by first to third flank face portions 13A, 13B, and 13C located at the first end 3a and having flank angles that stepwise increase toward the rear side in the rotation direction R2. As illustrated in FIG. 4, in the present embodiment, a pair of flank faces 13 are formed symmetrically to each other with respect to the rotational axis R1 in a front view. The flank face portion 13C in the present embodiment is a gash face.

The cutting edge 11 is located at an intersection of the flank face 13 and the flute 12 located forward the flank face 13 in the rotation direction R2. Specifically, the cutting edge 11 is formed at a ridge portion where the first flank face portion 13A and the flute 12, particularly, the opening of the flute 12 intersect each other. In the example of FIG. 4, the cutting edge 11 has a thinning edge 11a on the radially inner side. In the present embodiment, a pair of cutting edges 11 are formed symmetrically to each other with respect to the rotational axis R1 in a front view.

The flute 12 opens in the flank face 13 at the first end 3a, extends from the flank face 13 toward the second end 3b as illustrated in FIGS. 1 and 3, and functions to discharge chips generated by cutting with the cutting edge 11. In the present embodiment, a pair of flutes 12 extend symmetrically to each other with respect to the rotational axis R1 while twisting from the flank face 13 toward the second end 3b and are formed so as to be cut off before reaching the shank portion 4. From a standpoint of smoothly discharging chips to the outside, the flute 12 may have a concave curved shape in a cross section orthogonal to the rotational axis R1.

The coolant hole 14 extends from the second end 3b toward the first end 3a inside the body 3 and opens in the flank face 13. The coolant hole 14 has a function of ejecting a cooling liquid (coolant liquid) supplied from the second end 3b from the opening of the first end 3a to cool the rotary tool 1 and the workpiece T (refer to FIG. 8). It is also possible to make use of the cooling liquid in order to discharge the generated chips.

In the present embodiment, as illustrated in FIG. 4, a pair of coolant holes 14 are provided symmetrically with respect to the rotational axis R1. The pair of coolant holes 14 open so as to span the second flank face portion 13B and the first flank face portion 13A of the flank face 13. The coolant holes 14 are formed such that the shape and size in a cross section orthogonal to the rotational axis R1 are constant over the entire length of the body 3.

### <Shape of Coolant Hole>

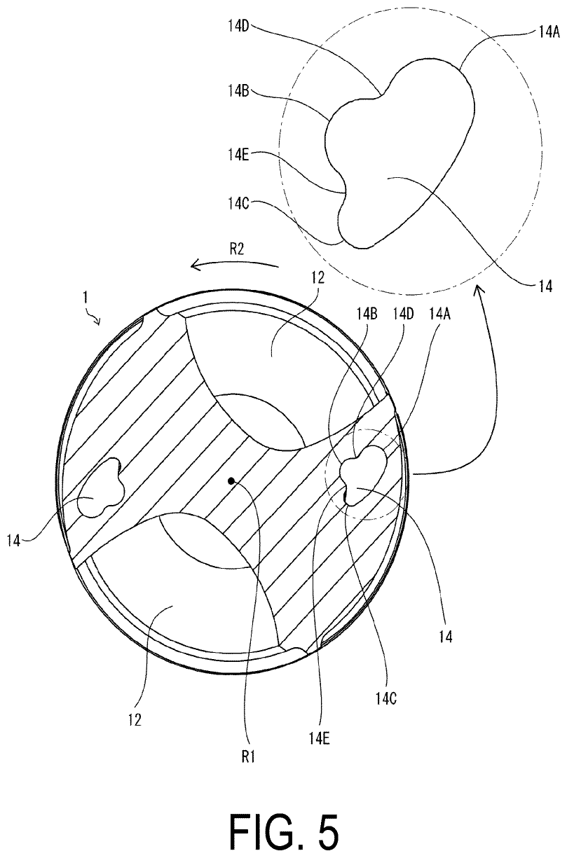

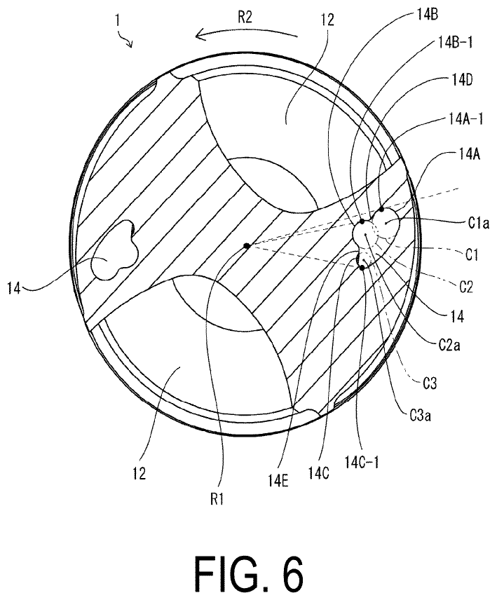

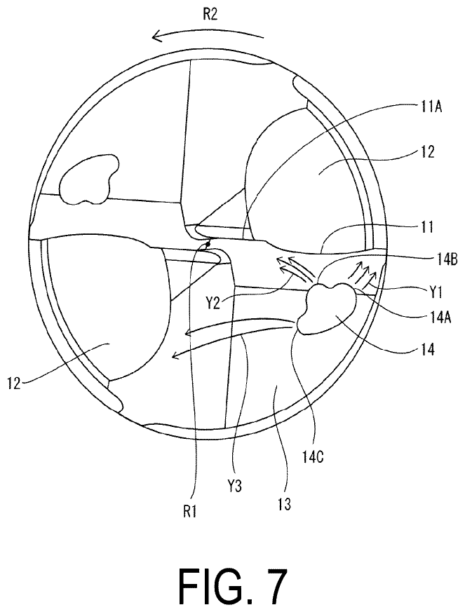

Next, the shape of the coolant hole 14 will be described in detail with reference to FIGS. 5 to 7. FIG. 5 is a cross-sectional view taken along an arrow line III-III in FIG. 3, and a partial enlarged view. FIG. 6 is a view illustrating a shape of the coolant hole 14 by using the cross-sectional view taken along the arrow line III-III in FIG. 3. FIG. 7 is a view illustrating a flow of the cooling liquid ejected from the coolant hole 14 by using the front view of the rotary tool 1.

As illustrated in FIG. 5, the coolant hole 14 has a first portion 14A, a second portion 14B, and a third portion 14C each having a convex curved shape in a cross section orthogonal to the rotational axis R1. The first portion 14A has a convex curved shape protruding toward a front in the rotation direction R2 and toward the outer peripheral side. The second portion 14B has a convex curved shape protruding toward the front in the rotation direction R2 and toward a central side. The third portion 14C has a convex curved shape protruding toward a rear in the rotation direction R2 and toward the central side.

1) The first portion 14A has a convex curved shape protruding toward the front in the rotation direction and toward the outer peripheral side. As a result, the cooling liquid ejected (discharged) from the first portion 14A flows toward an outer periphery-side portion (radially outer portion) of the cutting edge 11 located forward the coolant hole 14 in the rotation direction R2, as indicated by an arrow Y1 in FIG. 7. During cutting, the rotary tool 1 is rotated at a high speed in the rotation direction R2, so that centrifugal force acts toward the outer peripheral side. This centrifugal force allows the cooling liquid to be smoothly discharged toward the outer periphery-side portion of the cutting edge 11.

Since the outer periphery-side portion of the cutting edge 11 has a large rotation diameter from the rotational axis R1, an amount of generated chips, a cutting load, and generation of cutting heat are all large, and chipping of an edge tip is also likely to occur. However, the first portion 14A allows a large amount of cooling liquid to be supplied to the outer periphery-side portion of the cutting edge 11 and a cutting portion of the workpiece T (refer to FIG. 8) cut by the outer periphery-side portion to effectively cool the outer periphery-side portion and the cut portion.

2) The second portion 14B has a convex curved shape protruding toward the front in the rotation direction and toward a central side. As a result, the cooling liquid ejected from the second portion 14B flows toward a portion close to the center where the rotational axis R1 is located, as indicated by an arrow Y2 in FIG. 7. At the portion close to the center, the rotation speed is slow, but heat tends to accumulate. As a result, it is possible to supply a large amount of cooling liquid to the portion close to the center and a portion of the workpiece T (see FIG. 8) located in the portion and to effectively cool the portions.

3) The third portion 14C has a convex curved shape protruding toward the rear in the rotation direction and toward the central side. As a result, the cooling liquid ejected from the third portion 14C flows toward the flute 12 located behind the coolant hole 14 in the rotation direction R2 as indicated by an arrow Y3 in FIG. 7. The cooling liquid ejected from the rear side, in the rotation direction R2, of the opening of the coolant hole 14 is likely to be directed to the outer peripheral side due to the centrifugal force.

When the third portion 14C protrudes toward the outer peripheral side, the cooling liquid is likely to be discharged to the outside of the body 3 without flowing into the flute 12 located behind the coolant hole 14 in the rotation direction R2. However, by forming the third portion 14C in a shape that is convex toward the central side, a larger amount of cooling liquid can be directed to the flute 12 located on the rear side in the rotation direction R2 even when the centrifugal force is applied. As a result, a larger amount of cooling liquid can be supplied from the third portion 14C toward the flute 12 located on the rear side in the rotation direction R2, and the chips can be favorably discharged.

The coolant hole 14 has not only an opening portion in the flank face 13 as illustrated in FIG. 4, but also a first portion 14A to a third portion 14C in a cross section greatly distant away from the flank face 13 as illustrated in FIGS. 3 and 5. For example, it is assumed that the coolant hole 14 has the first portion 14A to the third portion 14C only in the vicinity of the opening portion in the flank face 13, and a shape of the coolant hole 14 in the cross section greatly distant away from the flank face 13 is circular. In this case, a flow path loss increases due to deformation of the shape of the coolant hole 14 in the cross section. For this reason, there is a concern that the above-described effects of the first portion 14A to the third portion 14C cannot be sufficiently obtained.

However, when the coolant hole 14 has the first portion 14A to the third portion 14C in the cross section greatly distant away from the flank face 13, the flow path loss inside the coolant hole 14 is likely to be suppressed. Therefore, the above-described effects of the first portion 14A to the third portion 14C are easily obtained.

As such, by forming the coolant hole 14 into the above-described shape, it is possible not only to cool the rotary tool 1 and the workpiece T (refer to FIG. 8) by the cooling liquid ejected from the coolant hole 14 but also to discharge generated chips by the cooling liquid.

As illustrated in FIG. 5, the coolant hole 14 may further have, in a cross section orthogonal to the rotational axis R1, a fourth portion 14D and a fifth portion 14E, each of which has a concave curved shape, or only one of the fourth portion 14D and the fifth portion 14E. The fourth portion 14D is located between the first portion 14A and the second portion 14B and has a concave curved shape recessed toward an inner side of the coolant hole 14. The fifth portion 14E is located between the second portion 14B and the third portion 14C and has a concave curved shape recessed toward the inner side of the coolant hole 14.

Narrowing a space between the first portion 14A and the second portion 14B each having a convex curved shape at the fourth portion 14D having a concave curved shape allows a discharge direction of the cooling liquid supplied from the first portion 14A and the second portion 14B to be narrowed down. Narrowing down the discharge direction also allows the momentum of the cooling liquid to be increased. Narrowing a space between the second portion 14B and the third portion 14C each having a convex curved shape at the fifth portion 14E having a concave curved shape allows a discharge direction of the cooling liquid supplied from the second portion 14B and the third portion 14C to be narrowed down. Narrowing down the discharge direction also allows the momentum of the cooling liquid to be increased.

As illustrated in FIG. 6, an end portion 14A-1 of the first portion 14A located on the front side in the rotation direction R2 may be farther from the rotational axis R1 than an end portion 14C-1 of the third portion 14C located on the rear side in the rotation direction R2. That is, the end portion 14A-1 is located on the outer peripheral side (radially outer side) farther from the rotational axis R1 than the end portion 14C-1. In FIG. 6, the end portion 14A-1 and the end portion 14C-1 are highlighted by black dots.

Such a configuration makes the first portion 14A for supplying the cooling liquid toward the outer periphery-side portion of the cutting edge 11 close to the outer peripheral side and allows a larger amount of cooling liquid to be supplied toward the outer periphery-side portion of the cutting edge 11 to more effectively cool the outer periphery-side portion.

As illustrated in FIG. 6, all of the first to third portions 14A, 14B, and 14C may be formed in an arc shape, and radii of curvature of the arc shapes may satisfy a relationship of the first portion 14A>the second portion 14B>the third portion 14C. That is, the first portion 14A has an arc shape having a first radius of curvature, the second portion has an arc shape having a second radius of curvature, and the third portion has an arc shape having a third radius of curvature. The first radius of curvature is larger than the second radius of curvature, and the second radius of curvature is larger than the third radius of curvature.

Such a configuration allows the discharge direction of the cooling liquid ejected from each of the first to third portions 14A, 14B, and 14C to further correspond to the cooling or discharge function required for each portion. Therefore, the coolant hole 14 can more effectively achieve both cooling and discharge of chips by the cooling liquid.

As illustrated in FIG. 6, centers of virtual circles C1 to C3 corresponding to the arc shapes of the first to third portions 14A, 14B, and 14C are defined as centers C1a to C3a, respectively. In this case, a positional relationship among the centers C1a and C3a may have an interval between the center C1a and the center C2a is shorter than an interval between the center C2a and the center C3a.

That is, a virtual circle corresponding to the arc shape of the first portion 14A is defined as a first virtual circle C1, a virtual circle corresponding to the arc shape of the second portion 14B is defined as a second virtual circle C2, and a virtual circle corresponding to the arc shape of the third portion 14C is defined as a third virtual circle C3. A center of the first virtual circle C1 is defined as a first center C1a, a center of the second virtual circle C2 is defined as a second center C2a, and a center of the third virtual circle C3 is defined as a third center C3a. In this case, an interval between the first center C1a and the second center C2a is shorter than an interval between the second center C2a and the third center C3a.

Such a configuration makes the first portion 14A close to the second portion 14B and allows a portion between a position close to a center and an outer periphery-side portion of the cutting edge 11 also to be effectively cooled by the cooling liquid ejected from each of the first portion 14A and the second portion 14B.

In this case, as illustrated in FIG. 6, the first virtual circle C1 and the second virtual circle C2 may intersect each other, and the third virtual circle C3 may be formed so as to be distant away from the first virtual circle C1 and the second virtual circle C2.

Such a configuration makes the first portion 14A closer to the second portion 14B. As a result, the portion between the position close to the center and the outer periphery-side portion of the cutting edge 11 can be more effectively cooled by the cooling liquid ejected from each of the first portion 14A and the second portion 14B.

As illustrated in FIG. 6, when the fourth portion 14D is provided, the fourth portion 14D may be recessed toward the rear in the rotation direction R2. When the fifth portion 14E is provided, the fifth portion 14E may be recessed toward the rear in the rotation direction R2 and toward the outer peripheral side.

Recessing the fourth portion 14D toward the rear in the rotation direction R2 allows an influence of the fourth portion 14D on the flow direction of the cooling liquid supplied from each of the first portion 14A and the second portion 14B to be reduced as much as possible, enabling the cooling liquid to easily flow toward the cutting edge 11. Narrowing down the discharge direction also allows the momentum of the cooling liquid to be increased. Recessing the fifth portion 14E toward the rear in the rotation direction R2 and toward the outer peripheral side allows the cooling liquid supplied from the second portion 14B to easily flow toward the cutting edge 11 and the cooling liquid supplied from the third portion 14C to easily flow toward the flute 12.

In this case, as illustrated in FIG. 6, the fourth portion 14D and the fifth portion 14E may each have an arc shape, and radii of curvature of the arc shapes may be smaller than the radii of curvature of the arc shapes of the first portion 14A to the third portion 14C. In other words, a fourth radius of curvature that is the radius of curvature of the arc shape of the fourth portion 14D may be smaller than the first radius of curvature, the second radius of curvature, and the third radius of curvature. A fifth radius of curvature that is the radius of curvature of the arc shape of the fifth portion 14E may be smaller than the first radius of curvature, the second radius of curvature, and the third radius of curvature.

Such a configuration allows the fourth portion 14D to have a compact configuration and regions of the first portion 14A and the second portion 14B to be likely to be wide. Accordingly, it is possible to achieve more effectively both cooling and discharge of chips by the cooling liquid while stably controlling the ejection direction of the cooling liquid supplied from the first portion 14A and the second portion 14B. The fifth portion 14E has a compact configuration, and regions of the second portion 14B and the third portion 14C are likely to be wide. Accordingly, it is possible to achieve more effectively both cooling and discharge of chips by the cooling liquid while stably controlling the ejection direction of the cooling liquid supplied from the second portion 14B and the third portion 14C.

As illustrated in FIG. 5, the coolant hole 14 may have a distance (interval) from the coolant hole 14 to the rotational axis R1 is larger than a distance (interval) from the coolant hole 14 to the outer peripheral surface of the body 3 in the cross section orthogonal to the rotational axis R1. That is, the coolant hole 14 may be formed close to the outer peripheral side of the body 3. Such a configuration can have a core thickness of the rotary tool 1 while providing the coolant hole 14.

As illustrated in FIG. 5, in the cross section orthogonal to the rotational axis R1, a distance from the coolant hole 14 to the flute 12 located forward the coolant hole 14 in the rotation direction R2 may be larger than a distance from the coolant hole 14 to the outer peripheral surface of the body 3. With such a configuration, the coolant hole 14 may be formed at a position closer to the outer peripheral surface of the body 3 than the cutting edge 11 to be cooled. Such a configuration can have a core thickness of the rotary tool 1 while providing the coolant hole 14.

2. Method for Manufacturing Machined Product Description will be given of a method for manufacturing a machined product according to an example by using FIG. 8. FIG. 8 is a schematic diagram illustrating a process of a method for manufacturing a machined product of an embodiment. A method for manufacturing a machined product U by machining the workpiece T using the rotary tool 1 will be described below.

The method for manufacturing the machined product U according to one embodiment of the present disclosure may include the following steps. Specifically,
(1) rotating the rotary tool 1,
(2) bringing the rotary tool 1 into contact with the workpiece T, and
(3) separating the rotary tool 1 from the workpiece T may be included.

More specifically, first of all, as indicated by the reference numeral 801 in FIG. 8, the workpiece T is prepared directly below the rotary tool 1, and the rotary tool 1 attached to the machine tool is rotated about the rotational axis R1. Examples of the workpiece T include aluminum, carbon steel, alloy steel, stainless steel, cast iron, and non-ferrous metals.

Next, as indicated by the reference numeral 802 in FIG. 8, the rotary tool 1 and the workpiece T are moved toward each other to bring the rotary tool 1 into contact with the workpiece T. Thus, the workpiece T is cut by the cutting edge 11, and a machined hole V is formed. A chip of the cut workpiece T is discharged outside through the flute 12. The rotary tool 1 and the workpiece T may be relatively moved toward each other in any manner that is not particularly limited. For example, the rotary tool 1 may be moved toward the workpiece T fixed, or the workpiece T may be moved toward the rotating rotary tool 1 fixed.

Then, as indicated by the reference numeral 803 in FIG. 8, the rotary tool 1 is separated from the workpiece T. As a result, the machined product U is manufactured as the workpiece T formed with the machined hole V.

The invention according to the present disclosure has been described above based on the various drawings and examples. However, the invention according to the present disclosure is not limited to each embodiment described above. That is, the embodiments of the invention according to the present disclosure can be modified in various ways within the scope illustrated in the present disclosure, and embodiments obtained by appropriately combining the technical means disclosed in different embodiments are also included in the technical scope of the invention according to the present disclosure. In other words, a person skilled in the art can easily make various variations or modifications based on the present disclosure. Note that these variations or modifications are included within the scope of the present disclosure.

### REFERENCE SIGNS

1 Rotary tool
3 Body
3a First end
3b Second end
10 Cutting portion
11 Cutting edge
12 flute
13 Flank face
14 Coolant hole
14A First portion
14A-1 End portion of first portion
14B Second portion
14C Third portion
14C-1 End portion of third portion
14D Fourth portion
14E Fifth portion
C1 First virtual circle
C1a First center
C2 Second virtual circle
C2a Second center
C3 Third virtual circle
C3a Third center
R1 Rotational axis
R2 Rotation direction

1. A rotary tool, comprising
a body extending along a rotational axis from a first end to a second end and having a cylindrical shape,
the body comprising:
a flank face located at the first end;
a flute extending from the flank face toward the second end and configured to discharge a chip;
a cutting edge located at an intersection of the flank face and the flute; and
a coolant hole extending from the second end toward the first end and opening in the flank face, and
the coolant hole comprising:
in a cross section orthogonal to the rotational axis,
a first portion protruding toward a front in a rotation direction of the rotational axis and toward an outer peripheral side and having a convex curved shape;
a second portion protruding toward the front in the rotation direction and toward a central side and having a convex curved shape; and
a third portion protruding toward a rear in the rotation direction and toward the central side and having a convex curved shape.

2. The rotary tool according to claim 1, wherein an end portion of the first portion located at a front in the rotation direction is farther away from the rotational axis than an end portion of the third portion located at a rear in the rotation direction.

3. The rotary tool according to claim 1,
wherein the first portion has an arc shape having a first radius of curvature,
the second portion has an arc shape having a second radius of curvature,
the third portion has an arc shape having a third radius of curvature,
the first radius of curvature is larger than the second radius of curvature, and
the second radius of curvature is larger than the third radius of curvature.

4. The rotary tool according to claim 3,
wherein a virtual circle corresponding to the arc shape of the first portion is defined as a first virtual circle,
a virtual circle corresponding to the arc shape of the second portion is defined as a second virtual circle,
a virtual circle corresponding to the arc shape of the third portion is defined as a third virtual circle,
a center of the first virtual circle is defined as a first center,
a center of the second virtual circle is defined as a second center,
a center of the third virtual circle is defined as a third center, and
an interval between the first center and the second center is shorter than an interval between the second center and the third center.

5. The rotary tool according to claim 4,
wherein the first virtual circle and the second virtual circle intersect each other, and
the third virtual circle is away from the first virtual circle and the second virtual circle.

6. The rotary tool according to claim 1, wherein the coolant hole comprises, in the cross section orthogonal to the rotational axis, a fourth portion located between the first portion and the second portion recessed toward an inner side of the coolant hole, and having a concave curved shape.

7. The rotary tool according to claim 6, wherein the fourth portion is recessed toward the rear in the rotation direction.

8. The rotary tool according to claim 6,
wherein the first portion has an arc shape having a first radius of curvature,
the second portion has an arc shape having a second radius of curvature,
the third portion has an arc shape having a third radius of curvature,
the fourth portion has an arc shape having a fourth radius of curvature, and
the fourth radius of curvature is smaller than the first radius of curvature, the second radius of curvature, and the third radius of curvature.

9. The rotary tool according to claim 1, wherein the coolant hole comprises, in the cross section orthogonal to the rotational axis, a fifth portion located between the second portion and the third portion, recessed toward an inner side of the coolant hole, and having a concave curved shape.

10. The rotary tool according to claim 9, wherein the fifth portion is recessed toward the rear in the rotation direction and toward the outer peripheral side.

11. The rotary tool according to claim 9,
wherein the first portion has an arc shape having a first radius of curvature,
the second portion has an arc shape having a second radius of curvature,
the third portion has an arc shape having a third radius of curvature,
the fifth portion has an arc shape having a fifth radius of curvature, and
the fifth radius of curvature is smaller than the first radius of curvature, the second radius of curvature, and the third radius of curvature.

12. The rotary tool according to claim 1, wherein in the cross section orthogonal to the rotational axis, a distance from the coolant hole to the rotational axis is larger than a distance from the coolant hole to an outer peripheral surface.

13. The rotary tool according to claim 1, wherein in the cross section orthogonal to the rotational axis, a distance from the coolant hole to the flute located forward the coolant hole in the rotation direction is larger than a distance from the coolant hole to an outer peripheral surface.

14. A method for manufacturing a machined product, the method comprising:
rotating a rotary tool according to claim 1;
bringing the rotary tool that is rotating into contact with a workpiece; and
separating the rotary tool from the workpiece.
